(19) United States
(12) Patent Application Publication
(10) Pub. No.: US 2001/0005870 A1
(43) Pub. Date: Jun. 28, 2001

(54) External bus control system

(75) Inventors: Kazumasa Suzuki, Tokyo (JP); Ryuuji Ishida, Tokyo (JP)

Correspondence Address: HELFGOTT & KARAS, P.C., 60th Floor, Empire State Building, New York, NY, 10118, US

(73) Assignee: NEC CORPORATION

(21) Appl. No.: 09/746,342

(22) Filed: Dec. 22, 2000

(30) Foreign Application Priority Data
Dec. 22, 1999 (JP) 11-365390

(51) Int. Cl. G06F 13/00

(52) U.S. Cl. 710/107

(57) ABSTRACT

There is provided an external bus control system for use in a single integrated circuit chip including a plurality of CPUs 1a, 1b, 1c equipped on the single IC chip and each capable of executing a program independently of the other processing units, and one external bus controller 2 equipped on the single IC chip and shared by the plurality of CPUs for controlling an external bus 3. Each of the CPUs includes a processor core 10, a DMA controller 11, a register 13 and a counter 14 for measuring an access to the external bus, and AND circuits 17a and 17b for internally generating an external bus write signal 123 and an external bus read signal 124. The external bus controller 2 includes a wait register 20 set with a wait number for accessing the external bus 3, and OR circuits 23a and 23b for externally outputting the external bus write signal 123 and the external bus read signal 124 from each CPU. The set value of the wait time is programmed by one CPU 1a, but can be used by each CPU together with the result of arbitration between requests of the use of said external bus. Thus, the overhead for allocating the access time for the external bus is no longer required.

### BACKGROUND OF THE INVENTION

The present invention relates to an external bus control system incorporated in one large scaled integrated circuit (LSI) comprising a plurality of processing units therein, for enabling that plurality of processing units share one common external bus controller but can independently execute respective individual programs. More specifically, the present invention relates to such an external bus control system allowing each of the processing units to locally have a wait time until accessing an external bus, and other control information.

A processing speed of a processing unit typified by a CPU (central processing unit) is increasing year by year. In a processor system (for example, an LSI) internally comprising such a high speed CPU, a difference between the processing of the processor system and various devices connected to an external bus of the processor system is increasing. As a result, an access to each of various internal functions within an LSI chip can be realized within one period of an operation clock, but a time of a few clocks is ordinarily required in the case of attempting to access an external peripheral circuit through an external bus.

In general, when data is exchanged between the CPU and the external peripheral circuit, the CPU transmits an access request signal to the external peripheral circuit. As a result, the CPU receives either an access enable signal or a wait request signal from the external peripheral circuit. Then, the CPU accesses the external bus at a suitable timing.

However, the exchange of these signals with the external peripheral circuit means that a time required for the exchange of these signals becomes an overhead in a time required for the access. Assuming that the external peripheral circuit is accessed only one time, the time of the overhead is negligible. However, when data is transferred between the CPU and an external memory connected to the external bus in a DMA (direct memory access) mode, the time of the overhead gives a large influence since the access to the external bus is repeated.

Here, the access to the external memory connected to the external bus needs a few clocks, but the time required for each access is at constant. Therefore, it is possible to control the CPU to wait while measuring a wait time by use of an external bus controller incorporated in the LSI chip. For this purpose, if an address assigned to each external memory is detected by the external bus controller, it is sufficient if the CPU is controlled to access a corresponding external memory on the basis of the wait time obtained in connection with the corresponding external memory.

For example, Japanese Patent Application Pre-examination Publication No. JP-A-08-030551 proposes a wait control system in which a counter is provided in an external bus controller to measure a wait time, and a wait signal is generated to stop the access processing of the CPU until the access is completed.

This wait time can be set by being programmed in a register provided in the external bus controller. Specifically, if an access to the external bus is generated, the counter of the external bus controller is initialized to a value programmed in the register, and the wait time is measured by counting down the initial value of the counter.

According to this wait control system, since the wait time is measured within the LSI chip, the above mentioned overhead time for exchanging the access request signal, the access enable signal and other control signals is no longer necessary.

Referring to FIG. 4, there is shown a block diagram illustrating the construction of an example of the prior art external bus control system.

The shown prior art external bus control system includes a CPU 200 and an external bus controller 201, and can execute a DMA transfer between an internal memory 212 in the CPU and a not-shown external memory connected to an external bus.

The external bus includes a group of address lines 300, a group of data lines 301, a line for a write signal 310 indicating a data writing to the external memory and other external peripheral circuits, and a line for a read signal 311 indicating a data reading from the external memory and other external peripheral circuits.

The CPU includes a processor core 210, a DMA controller 211, the internal memory 212, a decoder 213 for detecting the access to the external bus, and selectors 214a and 214b for switching the access between the processor core 210 and the DMA controller 211.

The external bus controller 201 includes a wait register 220 for holding a set value of the wait time until the access, and a counter for counting the wait time.

In the shown prior art external bus control system, the DMA controller 211 issues an address group 306 for the internal memory 212 and an address group 303 for the external bus in the process of the DMA transfer. The selectors 214b and 214a outputs an address 307 for the internal memory 212 and an address to the address lines 300.

If the decoder 213 receiving the address on the address lines 300 detects the access to the external bus, the decoder 213 outputs the write signal 314 or the read signal 315 for the external bus. In response to the signal 314 or 315, the counter 221 starts the counting operation to measure the previously set wait time. On the basis of the count value of the counter 221, the counter 221 issues an instruction for causing the DMA controller to generate a next address, and also generates a signal to AND circuits 222a and 222b for causing these AND circuits to output either a read signal 310 or a write signal 311 for the external bus.

In the above mentioned external bus control system, however, if the external bus is controlled by a plurality of CPUs, it becomes necessary to overcome the following problems:

Namely, the wait register 220 in the external bus controller 201 is set with the wait time in accordance with the program executed by the CPU. Here, if only one CPU 200 for executing a program is equipped on the LSI chip and connected to the external bus controller 201 in a one-to-one relation, there exists only one program for setting the wait value. Therefore, it is sufficient if the wait register is provided in the external bus controller.

However, with an advanced microfabrication technology, it has now become to possible to form a plurality of CPUs on a single LSI chip. In addition, each of the plurality of CPUs can execute a program independently of the others. In this case, if each of the CPUs is equipped with an independent external bus controller, it results in an increased number of input/output pins of the LSI chip. This is not so effective, since all of the input/output pins of the LSI chip are never used simultaneously.

Accordingly, it is preferred that one external bus controller is shared by all the CPUs. In other words, only one external bus controller should be equipped on the single LSI chip. In this case, it is convenient if the wait value is set in the wait register by the program executed by only one selected CPU, and the other CPUs execute an external access by using this set value.

In addition, if the size of the LSI becomes large, even if the external bus controller 201 is formed in the LSI chip, the time required for the access to the external bus controller becomes long. This is because the control signals for determining the access timing is delayed in an in-chip signal transmission path, with the result that the control efficiency drops.

Under this circumstance, it is preferred that the counter 211, which was provided in the external bus controller 201, is provided into each of the CPUs, since the DMA controller 221 generates an address. For this purpose, however, it is required that the value of the wait register is locally set within one CPU but is shared by all the CPUs.

### BRIEF SUMMARY OF THE INVENTION

Accordingly, it is an object of the present invention to provide an external bus control system for an LSI including a plurality of CPUs equipped in a single LSI and an external bus controller equipped in the single LSI but shared by the plurality of CPUs, so that a set value of an external bus access time can be shared by the plurality of CPUs to realize an effective control.

Another object of the present invention is to provide an external bus control system which does not need an overhead for allocating an external bus access time.

The above and other objects of the present invention are achieved in accordance with the present invention by an external bus control system for use in a single integrated circuit chip including a plurality of processing units equipped on the single integrated circuit chip and each capable of executing a program independently of the other processing units, and one external bus controller equipped on the single integrated circuit chip and shared by the plurality of processing units for controlling an external bus, wherein each of the plurality of processing units includes a counting means for measuring a wait time until the processing unit can monopolize the external bus, the external bus controller controlling the external bus on the basis of a timing given by the counting means.

With this arrangement, since the wait time for the external bus is measured in each processing unit, there is no wasteful delay in a timing for controlling the access to the external bus.

In one embodiment of the external bus control system in accordance with the present invention, the counting means includes a counter for measuring the wait time of the processing unit to generate the timing for monopolizing the external bus, and a local register set to hold a wait time to be measured by the counter

With this arrangement, the wait time for the external bus is held in the local register of each processing unit, and the control timing for accessing to the external bus is generated by the counter.

In a preferred embodiment of the external bus control system in accordance with the present invention, the external bus controller includes therein a common register set with a set value of the wait time, and the external bus controller transfers the set value of the wait time from the common register to the local register of each processing unit.

With this arrangement, by action of the common register, the set value of the wait time for the external bus is shared by the plurality of processing units.

In the embodiment of the external bus control system in accordance with the present invention, for example, at each time the processing unit requests an exclusive use of the external bus, the external bus controller transfers the set value of the wait time. With this arrangement, the set value of the wait time for the external bus is transferred from the common register to each processing unit.

In a preferable embodiment of the external bus control system in accordance with the present invention, the external bus controller transfers the set value of the wait time together with the result of arbitration between requests of the use of the external bus from a plurality of processing units. With this arrangement, the set value of the wait time for the external bus and the result of arbitration of the exclusive use of the external bus are simultaneously transferred to each processing unit.

In another preferable embodiment of the external bus control system in accordance with the present invention, the external bus controller transfers the set value of the wait time only when each of the processing units is a direct memory access mode. With this arrangement, in the direct memory access mode transfer of each processing unit, the set value of the wait time for the external bus is transferred to each processing unit.

The above and other objects, features and advantages of the present invention will be apparent from the following description of preferred embodiments of the invention with reference to the accompanying drawings.

### BRIEF DESCRIPTION OF THE DRAWINGS

FIG. 1 is a block diagram illustrating the construction of one embodiment of the external bus control system in accordance with the present invention;

FIGS. 2 and 3 are control procedure diagrams illustrating a sequence of control procedures in the external bus control system shown in FIG. 1; and

FIG. 4 is a block diagram illustrating the construction of an example of the prior art external bus control system.

### DETAILED DESCRIPTION OF THE INVENTION

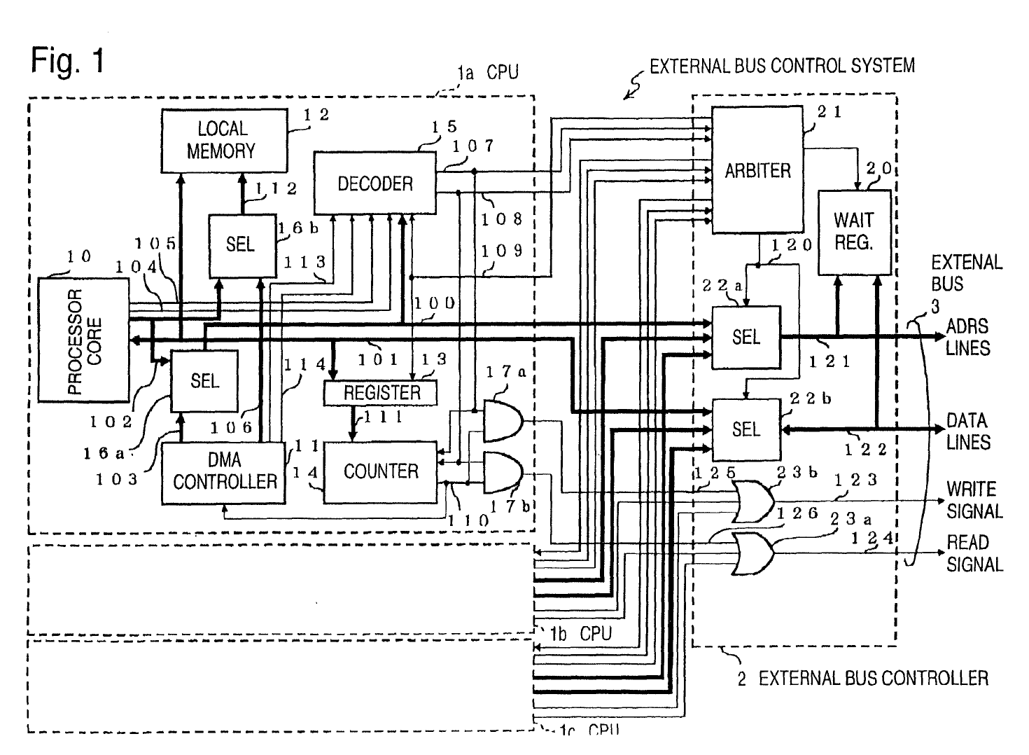

Referring to FIG. 1, there is shown a block diagram illustrating the construction of one embodiment of the external bus control system in accordance with the present invention.

The shown external bus control system includes three CPUs 1a, 1b and 1c and one common external bus controller 2 shared by the three CPUs 1a, 1b and 1c. The three CPUs 1a, 1b and 1c and the common external bus controller 2 are equipped on a single LSI chip, and an external bus 3 is constituted of a group of address lines 121, a group of data lines 122, a line for a write signal 123, and a line for a read signal 124.

The CPU 1a mainly includes a processor core 10, a DMA controller 11, a local memory 12, a register 13 and a counter 14 for measuring an access time for the external bus, and a decoder 15 for detecting the access to the external bus. Since each of the CPU 1b and 1c has the same construction as that of the CPU 1a, explanation of the CPUs 1b and 1c will be omitted, and therefore, the following description will be focused onto only the CPU 1a.

Each of the processor core 10 and the DMA controller 11 can dispatches a request to access the local memory 12 and the external bus 3. Therefore, an address 100 to be supplied to the external bus and an address 112 to be supplied to the local memory 12 are determined by action of selectors 16a and 16b on the basis of respective operations of the processor core 10 and the DMA controller 11. In addition, a write signal 125 and a read signal 126 to be outputted to the external bus are outputted in accordance with an external bus accessing timing, by action of two AND circuits 17a and 17b.

The external bus controller 2 includes a wait register 20 for setting a wait number when the external bus is accessed, and an arbiter circuit 21 for determining which of the CPUs 1a, 1b and 1c is given with the exclusive use of the external bus controller 2. In accordance with the result of the arbitration, selectors 22a and 22b are controlled to connect the external bus with an internal bus of a selected CPU of the CPUs 1a, 1b and 1c. The external bus controller 2 also includes OR circuits 23a and 23b to output the write signal 125 and the read signal 126 as a write signal 123 and a read signal 124 to the external bus.

The processor core 10 outputs either a write signal 104 or a read signal 105 to the decoder 15. Similarly, the DMA controller either a write signal 113 or a read signal 114 to the decoder 15. In response to these signals, the decoder 15 generates a write signal 107 or a read signal 108, which are supplied to the OR circuits 23a and 23b and the counter 14 within the same CPU 1a and to the arbiter circuit 21 of the external bus controller 2

In this embodiment, a wait time is determined by a wait number.

Now, an operation when each CPU executes a DMA transfer will be described.

The DMA controller 11 of the CPU 1a generates an address 106 to be supplied to the local memory 12 and an address 103 to be supplied to the external bus controller 2. The address 106 is selected by the selector 16b as the address 112 to be supplied to the local memory 12, and the address 103 is selected by the selector 16a as the address 100 to be supplied to the external bus controller 2.

The decoder 15 receiving the address 100 to be supplied to the external bus controller 2, detects the access to the external bus, and generates either a write signal 107 or a read signal, which are supplied to the arbiter circuit 21 as an access request. The arbiter circuit 21 outputs an external bus use enable signal 109 to a selected CPU 1a. In addition, the arbiter circuit 21 outputs a selection control signal 120 to the selectors 22a and 22b so that the internal address bus 100 of the selected CPU 1a is connected through the selector 22a to the external bus 3, and the internal data bus 101 is connected through the selector 22b to the external bus 3.

When the arbiter circuit 21 outputs the external bus use enable signal 109, the arbiter circuit 21 cause the wait number set in the wait register 20 in the external bus controller 2 to be transferred through the data lines 122 of the external bus to the internal data bus 101 of the CPU 1a. The value of the wait number thus transferred is registered in the local register 13 of the CPU 1a. Thus, the counter 14 coupled with the register 13 starts its counting operation to measure the access time while referring to the register 13.

If the counter 14 completes the counting of the wait number thus set, it is deemed that one access operation to the external bus is completed, and therefore, the counter 14 outputs a control signal 110 for notification of the access completion. In response to this control signal 110, the DMA controller generates a next address value, and the AND circuits 17a and 17b generate the write signal 125 and the read signal 126 as the write signal 123 and the read signal 124 to the external bus.

As mentioned above, the counter 14 for generating the timing of the access to the external bus is provided in the proximity of the DMA controller within each CPU. As a result, since no substantial time is required to transfer the control signal, the timing of the access can be controlled in a simple construction.

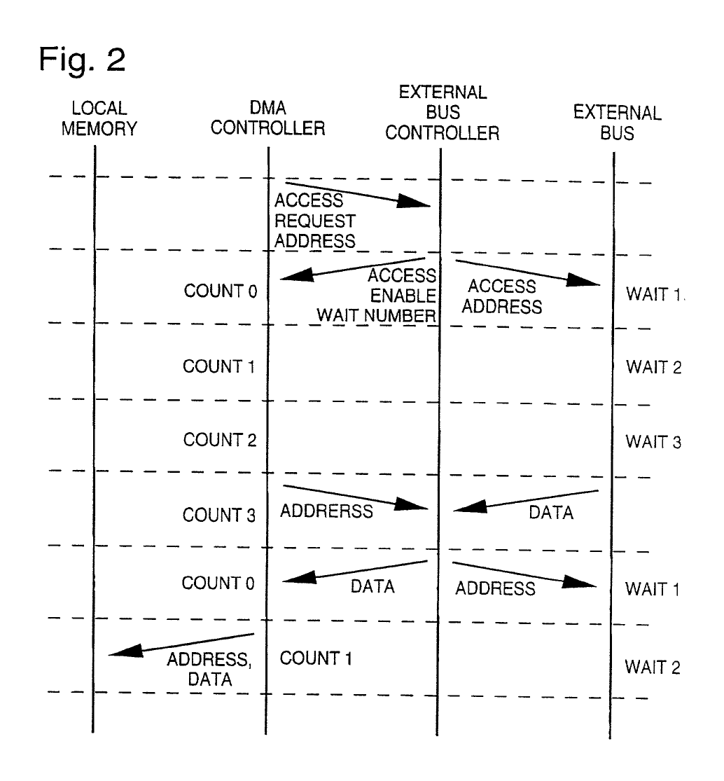

Referring to FIG. 2, there is shown a control procedure diagram illustrating a sequence of control procedures in the external bus control system shown in FIG. 1 when data is transferred from the external bus to the local memory in the DMA mode.

In FIG. 2, the local memory 12, the DMA controller 11, the external bus controller 2, and the external bus 3 are diagrammatically located along the axis of abscissas, so that the transfer direction of data and an address between these function units is illustrated. The axis of ordinates shows the lapse of time by dotted lines which are separated from each other by the lapse of time corresponding to one clock.

Recently, the circuit size realized on one LSI chip becomes vary large, and the frequency of an operation clock of the LSI increases, with the result that a delay on the order of one clock usually occurs in a data transfer within the LSI chip. Therefore, when the exclusive use is arbitrated to determine which of the CPUs acquires the exclusive use of the external bus controller 2, since one control signal is transmitted in one direction and then another control signal is transmitted in an opposite direction, the time corresponding to two clocks is required.

In a first clock period, when the DMA controller 11 dispatches an access request to the external bus controller 2, the address 100 is simultaneously transferred. In a second clock period or a further succeeding clock period, a use enable signal 109 is returned back from the external bus controller. Thus, if only one CPU dispatches an access request, the access is enabled in the next clock period without exception.

Together with use enable signal 109, the wait number set in the wait register 20 within the external bus controller 2 is transferred so that the wait number is registered in the register 12 in the proximity of the DMA controller within the CPU 1a.

On the other hand, assuming that the time when the access is enabled or allowed is a count “0”, the counter 14 starts its count-up operation to increment at each clock. For example, if it is assumed that three clocks are set as the wait number, the counter 14 outputs the control signal 110 to the DMA controller 11 at the count “3”, which dispatches the address 100 for the DMA transfer. Succeedingly, in a next clock period, data obtained in a just preceding access is transferred through the external bus controller, and therefore, is stored in the local memory 12 in a succeeding clock period.

After the counter 14 reaches the count “3”, the counter 14 restarts its count-up operation from the count “0”, again. Thus, the counting operations of the number corresponding to a necessary data amount are repeated, so that all the necessary data is continuously transferred.

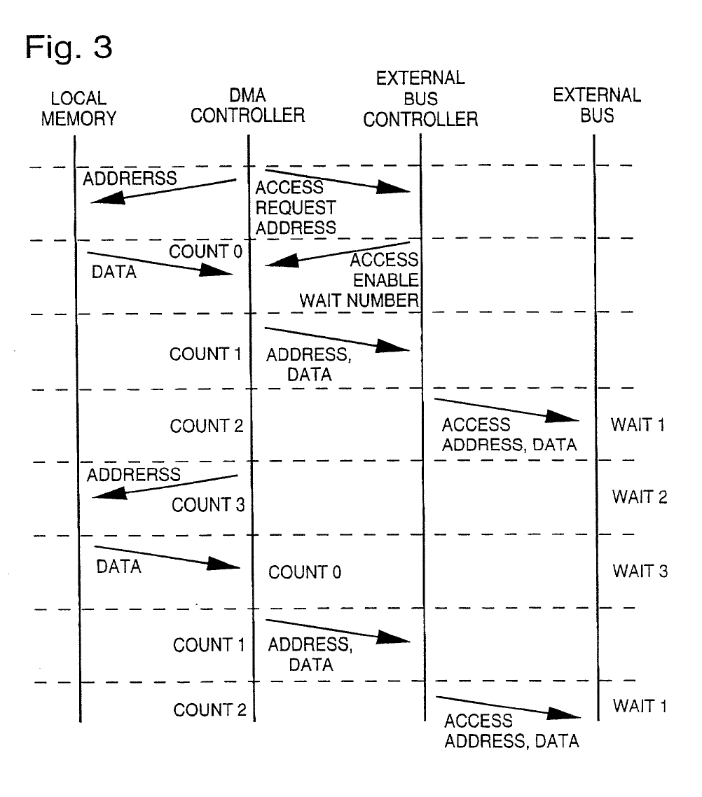

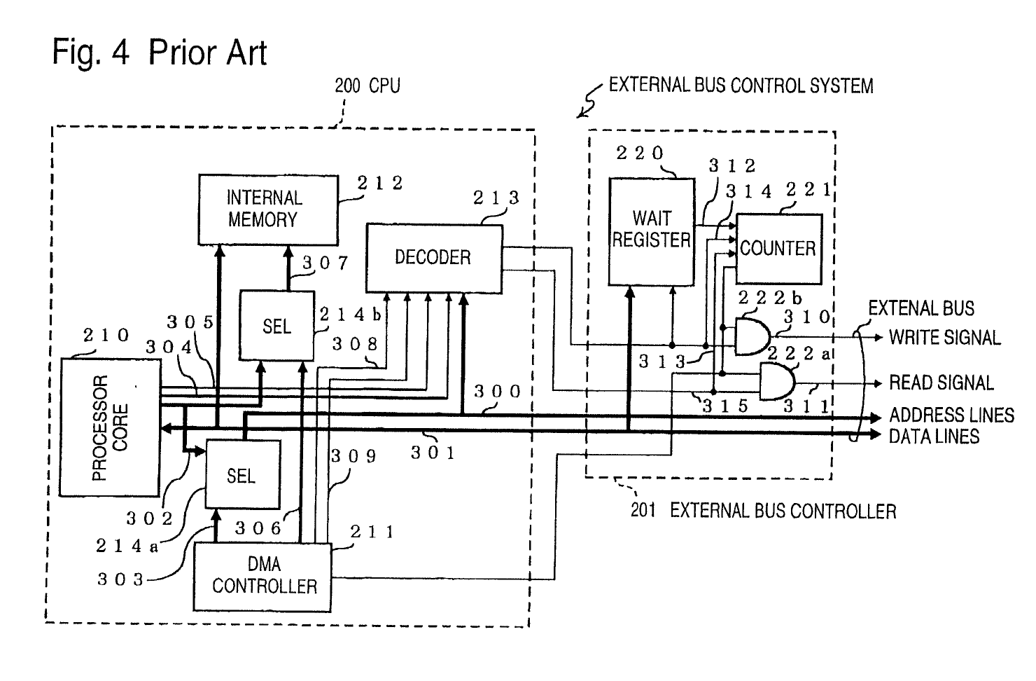

Referring to FIG. 3, there is shown a control procedure diagram illustrating a sequence of control procedures in the external bus control system shown in FIG. 1 when data is transferred from the local memory to the external bus.

In a first clock period, when the DMA controller 11 dispatches an access request to the external bus controller 2, the address 100 is simultaneously transferred. In a second clock period or a further succeeding clock period, a use enable signal 109 is returned back from the external bus controller 2. At this time, the wait number is transferred together with the use enable signal 109.

On the other hand, assuming that the time when the access is enabled or allowed is a count “0”, the counter 14 starts its count-up operation to increment at each clock. Within an access arbitrating period in the external bus controller 2, the processor core 10 accesses the local memory to read data to be outputted. In a next clock period, the data read out from the local memory 14 at the time of the count “0”, is transferred together with the address 100 to the external bus controller 2.

In a clock period succeeding the next clock period, the address 121 and the data 122 are outputted from the external bus controller 2 to the external bus 3.

When the counter 14 reaches the count “3” (which is equal to the set wait number), an address 112 for data to be transferred next is dispatched to the local memory 12. In a next clock period, data 101 is read out from the local memory 12, and in a clock period succeeding the next clock period, the address 100 and the data 101 are outputted to the external bus controller 2.

Similarly, after the counter 14 reaches the count “3”, the counter 14 restarts its count-up operation from the count “0”, again. Thus, the counting operations of the number corresponding to a necessary data amount are repeated, so that all the necessary data is continuously transferred.

In this operation, similarly to the above mentioned operation, since the counter 14 is in the proximity of the DMA controller 11, it is possible to easily generate the timing for outputting the address to the local memory 12 and the external bus controller 2.

When the wait time is set by a program as mentioned above, it is sufficient if only one CPU 1a sets the wait register 20 within the external bus controller 2 in accordance with the program. In other word, the wait time can be set only by giving a program for setting the wait time to only one of the plurality of CPUs 1a, 1b and 1c.

In addition, when the DMA transfer is started, the set value of the wait number is transferred to the register 13 in the CPU 1a which starts the DMA transfer. Therefore, a CPU which did not execute the program for setting the wait time, can acquire the latest wait number. Therefore, if the value of the wait register had been updated before that CPU starts the DMA transfer, that CPU can execute the DMA transfer using the latest wait number. Accordingly, a safe DMA transferred can be ensured.

Furthermore, since the set value of the wait number can be transferred together with the result of the access arbitration performed by the external bus controller 2, a new overhead is not added in the sequence of control procedures.

In the above mentioned embodiment, the wait number is transferred. However, when information shared by the CPUs 1a, 1b and 1c is transferred together with the wait number, if the information is transferred through the data bus at the same time as the result of the access arbitration is transferred, the overhead in the transfer time is not increased.

In addition, in an ordinary bus access in which the processor core 10 generates the address 102, the influence of an increase of the overhead in the data transfer is small. Therefore, it is possible to provide a counter within the external bus controller 2, so that the measurement of the wait time can be executed within the external bus controller 2.

Incidentally, since the counter 14 for generating the access timing can be constituted on the order of 6 bits, the increased amount of the hardware is entirely negligible in a modern LSI process, and therefore, the fabrication cost does not increases.

The invention has thus been shown and described with reference to the specific embodiments. However, it should be noted that the present invention is in no way limited to the details of the illustrated structures but changes and modifications may be made within the scope of the appended claims.

The above mentioned embodiment includes the three CPUs. The number of CPUs is in now way limited to this number. Even if a different number of CPUs are provided, a similar control can be used. In addition, the processing unit is not limited to only the CPU, but can be formed of other processing means such as a digital signal processor.

As seen from the above, according to the present invention, even if a plurality of processing units are equipped on a single LSI chip so that the circuit size of the LSI becomes large, the external bus can be efficiently controlled. The reason for this is that a counter for measuring the wait time for the external bus is provided with each processing unit, no substantial delay occurs in the signal for controlling the wait of the external bus access timing.

Furthermore, even the wait time for the external bus shared by a plurality of processing units is set by one processing unit, the set wait time can be locally utilized by the other processing units. In addition, the wait control can be realized by using a modern set value. The reason for this is that at each time each processing unit starts to use the external bus, the processing unit acquires the set value of the wait time from the register in the external bus controller.

Moreover, each processing unit can locally acquire the set value of the wait time with no new overhead. The reason for this is that the set value of the wait time is transferred from the common register at the same time as the result of the access arbitration for determining the processing unit exclusively utilizing the external bus is transferred.

Finally, the content of the basic Japanese Patent Application No. 365390/1999 filed on Dec. 22, 1999 is incorporated by reference in its entirety into this application.

1. An external bus control system for use in a single integrated circuit chip including a plurality of processing units equipped on the single integrated circuit chip and each capable of executing a program independently of the other processing units, and one external bus controller equipped on the single integrated circuit chip and shared by the plurality of processing units for controlling an external bus, wherein each of said plurality of processing units includes a counting means for measuring a wait time until said processing unit can monopolize said external bus, said external bus controller controlling said external bus on the basis of a timing given by said counting means.

2. An external bus control system claimed in claim 1 wherein said counting means includes a counter for measuring the wait time of the processing unit to generate said timing for monopolizing said external bus, and a local register set to hold a wait time to be measured by said counter.

3. An external bus control system claimed in claim 2 wherein said external bus controller includes therein a common register set with a set value of said wait time, and said external bus controller transfers said set value of said wait time from said common register to said local register of each processing unit.

4. An external bus control system claimed in claim 3 wherein at each time said processing unit requests an exclusive use of said external bus, said external bus controller transfers said set value of said wait time.

5. An external bus control system claimed in claim 4 wherein said external bus controller transfers said set value of said wait time together with the result of arbitration between requests of the use of said external bus from a plurality of processing units.

6. An external bus control system claimed in claims 5 wherein said external bus controller transfers said set value of said wait time only when each of said processing units is a direct memory access mode.

7. An external bus control system claimed in claim 3 wherein said external bus controller transfers said set value of said wait time together with the result of arbitration between requests of the use of said external bus from a plurality of processing units.

8. An external bus control system claimed in claims 7 wherein said external bus controller transfers said set value of said wait time only when each of said processing units is a direct memory access mode.

9. An external bus control system claimed in claims 3 wherein said external bus controller transfers said set value of said wait time only when each of said processing units is a direct memory access mode.

10. An external bus control system claimed in claim 1 wherein said external bus controller includes therein a common register set with a set value of said wait time, and said external bus controller transfers said set value of said wait time from said common register to said local register of each processing unit.

11. An external bus control system claimed in claim 10 wherein at each time said processing unit requests an exclusive use of said external bus, said external bus controller transfers said set value of said wait time.

12. An external bus control system claimed in claim 11 wherein said external bus controller transfers said set value of said wait time together with the result of arbitration between requests of the use of said external bus from a plurality of processing units.

13. An external bus control system claimed in claims 12 wherein said external bus controller transfers said set value of said wait time only when each of said processing units is a direct memory access mode.

14. An external bus control system claimed in claim 10 wherein said external bus controller transfers said set value of said wait time together with the result of arbitration between requests of the use of said external bus from a plurality of processing units.

15. An external bus control system claimed in claims 14 wherein said external bus controller transfers said set value of said wait time only when each of said processing units is a direct memory access mode.

16. An external bus control system claimed in claims 10 wherein said external bus controller transfers said set value of said wait time only when each of said processing units is a direct memory access mode.
